(19) United States
(12) Patent Application Publication
(10) Pub. No.: US 2007/0073897 A1
(43) Pub. Date: Mar. 29, 2007

(54) Optimal sequenced route query operation and device

(76) Inventors: Mehdi Sharifzadeh, Los Angeles, CA (US); Mohammad Reza Kolahdouzan, Pasadena, CA (US); Cyrus Shahabi, Irvine, CA (US)

Correspondence Address: FISH & RICHARDSON, PC, P.O. BOX 1022, MINNEAPOLIS, MN, 55440-1022, US

(21) Appl. No.: 11/472,495

(22) Filed: Jun. 20, 2006

Related U.S. Application Data
(60) Provisional application No. 60/692,730, filed on Jun. 21, 2005.

(51) Int. Cl. G06F 15/173

(52) U.S. Cl. 709/238

(57) ABSTRACT

A computer system that finds an optimal sequenced route through one point from each of a plurality of categories. The routes are found by determining one point from each of the categories and finding the shortest path through the one point through each of those routes.

### CROSS-REFERENCE TO RELATED APPLICATIONS

This application claims priority to U.S. Application Ser. No. 60/692,730, filed on Jun. 21, 2005. The disclosure of the prior application is considered part of (and is incorporated by reference in) the disclosure of this application.

### FEDERALLY SPONSORED RESEARCH OR DEVELOPMENT

The U.S. Government may have certain rights in this invention pursuant to Grant Nos. EEC-9529152, IIS-0324955 (ITR) and IIS-0238560 (PECASE) awarded by NSF.

### BACKGROUND

A nearest neighbor query looks to a group of objects to find the object among the group that has the shortest distance to a query point. Different variations on this query are possible.

An application of this query may be used when a user wants to plan several trips to different locations in some sequence. The user may alternatively desire to make a trip to different types of locations in some sequence. It may be desirable to find the optimal route between the points selected in this way.

### SUMMARY

The present application describes techniques which enable determination of an optimal sequenced route.

Embodiments describe techniques to carry this out via a query, for example, using spatial databases. Other embodiments describe techniques to minimize the amount of processing, and/or the memory space, used for this operation.

### BRIEF DESCRIPTION OF THE DRAWINGS

FIG. 1 shows an example network with a different point sets;

FIG. 2 shows a weighted directed graph for an embodiment;

FIGS. 3a-3h show different iterations carried out in a first embodiment;

FIG. 4 illustrates a computer system which can be used to carry out the embodiment;

FIG. 5 shows a locus of points for an embodiment operating in vector space; and

FIG. 6 illustrates how the operation can be carried out in a range query;

FIGS. 7 and 8 show flowcharts of embodiments.

### DETAILED DESCRIPTION

The embodiment describes a feature called the optimal sequenced route determination. The determination can be made based on a query. Consider one application of the optimal sequenced route query.

A user may plan a trip, for example by automobile, where the trip planner intends to first leave home towards a gas station to fuel the car, then to a library branch to check in a book, and finally to a post office to mail a package. The user typically prefers to drive the minimum overall distance.

Defining the locations of the points, with gas station gi, library branch lj, and post office pk, the problem can be considered as one of choosing the sequence between these points which shortens the trip in distance or time. The way of doing this may be based on the user's preferences, that is considering distance or time. This route is referred to herein as the optimal sequenced route.

Commercial applications for this kind of nearest neighbor query may include automated navigation devices for vehicles and computerized map services. These queries may also be used in crisis management, as well as in defense and intelligence systems. This kind of query may be useful to provide an ability to respond to a series of incidences in an absolute fastest time in these and other analogous applications.

Simply performing a series of independent nearest neighbor queries to the different locations will produce an answer, however, one that is not likely to be the optimal answer.

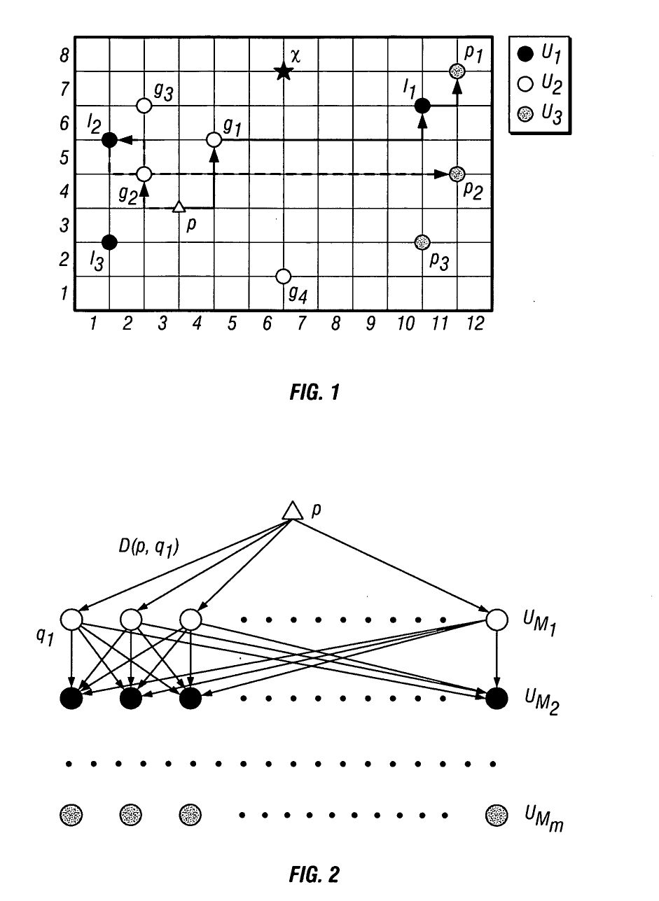

FIG. 1 illustrates the three different types of point sets as shown by the darkened points, shaded points, and hollow points. These may represent, for example, different gas stations, libraries, and post offices. A starting point, represented by x—the star. FIG. 1 also shows an array of equally sized connecting squares. Simply finding the nearest points to other nearest points will not necessarily solve the problem optimally.

One simple way of solving the problem will be dubbed the “greedy” approach. The greedy approach might first locate the closest gas station to p, which in FIG. 1 is g2, then find the closest library to g2, which in FIG. 1 is l2. Finally, one would find the closest post office to l2 which is p2. Calling the length of each edge of each square one unit, the total length of the route specified by the greedy approach would be the set (p, g1, l1, p1). FIG. 1 shows this in solid lines. Using this greedy approach provides a length of 12 units as the optimum answer to the query.

However, examining FIG. 1 deterministically shows the g1 is not in fact the closest library to p, and that l1 is actually the farthest library from g1. In other words, the true optimum for a specific query may be very different than the greedy approach. However, the greedy approach is relatively simple to calculate. In embodiments, the greedy approach is used to determine an answer that will be used for reduction of the calculation space. More generally, any technique that finds an answer using a single analysis step for each segment of the path can be used for this reduction.

Embodiments describe finding the optimal sequenced route. The problem of doing so is closely related to the known traveling salesman problem. The traveling salesman problem asks for an the minimum “cost” of a round-trip route from a starting point to a given set of points. The traveling salesman problem is effectively a search for the Hamiltonian cycle with the least weight in a weighted graph. There are, however, differences between the traveling salesman problem, and the present problem of optimal sequenced route. While the traveling salesman problem requires that all of the points in the set be visited, the optimal sequenced route enforces a specific sequence to find the appropriate points from a point in a set.

Another similar problem is the sequential ordering problem, in which a Hamiltonian path with a specific node precedence constraint is required. The sequential ordering problem, however, requires a solution which passes through all the points in the set, like in all the traveling salesman problems.

The inventors recognized that certain applications require a very different analysis, specifically efficient selection of the sequence of points of each of which can be any member of the given point set. This differs from many conventional searches of this type, such as the Yellow Pages on Yahoo and MapQuest. The search only for the K-nearest neighbors in one specific category or point set to a given query location cannot find the optimal sequenced route from the query to a group of point sets.

The embodiment describes how this new kind of query can be carried out.

Defining the problem—U1, U2, U3 . . . Un are n sets, each containing points in a d-dimensional space R^{d}. D(.) is a distance metric defined in R^{d}, where D(.) obeys the triangular inequality.

As an example, FIG. 1 has the sets U1, U2 and U3, respectively, representing the black, white and gray points and, respectively, representing libraries, gas stations and post offices.

First, this is defined mathematically according to the following definitions according to the table of notations reproduced in table 1.

Definition 1: Given n, the number of point sets Uᵢ, we say M−(Mₗ, Mₛ, . . . , Mₘ) is a sequence if and only if 1≦Mᵢ≦n for 1≦i≦m. That is, given the point sets Uᵢ, a user's OSR query is valid only if asking for existing location types. For the example of FIG. 1 where n=3, (2,1,2) is a sequence (specifying a gas station, a library, and a gas station) while (3,4,1) is not because 4 is not an existing point set.

Definition 2: R=(P₁,P₂, . . . ,Pᵣ) is a route if and only if PᵢεR^{d} for each 1≦i≦r. p⊕R=(p,P₁, . . . ,Pᵣ) denotes a new route that starts from starting point p and goes sequentially through P₁ to Pᵣ. The route p⊕R is the result of adding p to the head of route R.

Definition 3: The length of a route R=(P₁, P₂, . . . , Pᵣ) is defined as

$$L ( R ) = {\sum }_{i = 1}^{r - 1} D ( {P}_{i} {P}_{i + 1} ) \qquad ( 1 )$$

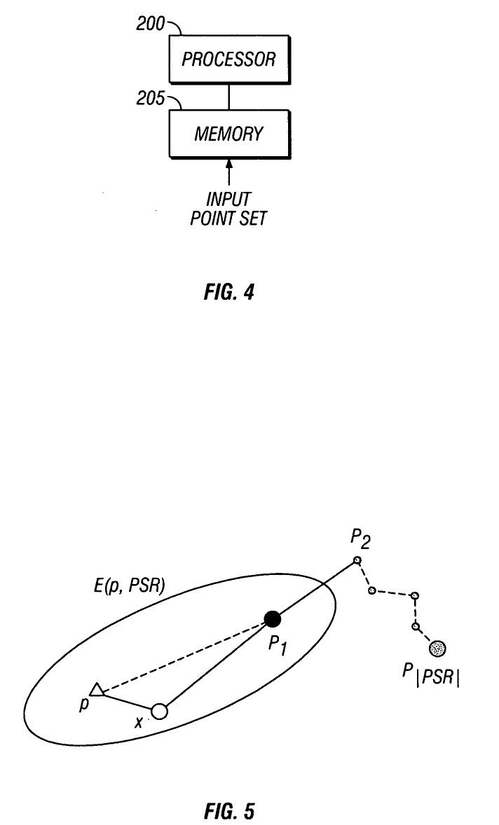

Note that L(R)=0 for r=1. For example, the length of the route (g₂, l₂, g₃) in FIG. 4 is 4 units where D is the Manhattan distance.

Definition 4: Let M=(M₁, M₂, . . . , Mₘ) be a sequence. We refer to the route R=(P₁,P₂, . . . ,Pₘ) as a sequenced route that follows sequence M if and only if PᵢεU_{M}_{ᵢ} where 1≦i≦m. In FIG. 1, (g₂, l₂, g₃) is a sequenced route that follows (2,1,2) which means that the route passes only through a white, then a black and finally a white point.

Definition 5: given the starting point p, a sequence M=(M₁, . . . , Mₘ), and point sets {U₁ . . . , Uₙ}, we refer to R_{g}(p, M=(P₁, . . . , Pₘ) as the greedy sequenced route that follows M from point p if and only if it satisfies the following:

1. P₁ is the closed point o p in U_{M}_{ᵢ}, and

2. For 1≦I<m, Pᵢ₊₁ is the closest point to Pᵢ in U_{M}_{ᵢ₊₁}.

R_{g}(p,M) is unique for a given point p, a sequence M, and the sets Uᵢ. Moreover, by definition, the optimal sequenced route R is never longer than the greedy sequenced route for the given sequence M, i.e., L(p,R)≦L(p, R_{g}(p,M)).

The actual query for the optimal sequenced route is then defined as:

Definition 6: Assume that we are given a sequence M=(M1, M2 . . . , Mm). For a given starting point p in R^{d} and the sequence M, the Optimal Sequenced Route (OSR) Query, Q(p,M), is defined as finding a sequenced route R that follows M where the value of the following function L is minimum over all the sequenced routes that follow M:
L(p,R)=D(p,P₁)+(L(R) (2)

Note that L(p,R) is in fact the length of route Rₚ=p⊕R.

Q(p,M)=(P₁,P₂, . . . , Pₘ) is used to denote the optimal SR, the answer to the OSR query Q. For the example above where (U₁, U₂, U₃)=(black, white, gray), M=(2,1,3), and D is the shortest path, the answer to the OSR query is Q(p,M)=(g₁, l₁, p₁). The term “candidate SR” is used to refer to all other sequenced routes that follow sequence M.

In order to find the query, a number of properties all the points are used to advantage.

Property 1: for a route R=(P₁, . . . ,Pᵢ, Pᵢ₊₁, . . . ,Pᵣ) and a given point p:
L(p,R)≧D(p,Pᵢ)+L((Pᵢ, . . . ,Pᵣ)) (3)

Proof: The triangular inequality implies that

$$D ( p , {P}_{1} ) + {\sum }_{j = 1}^{i - 1} D ( {P}_{j} , {P}_{j + 1} ) \geq D ( p , {P}_{i} ) adding {\sum }_{j = 1}^{r - 1} D ( {P}_{j} , {P}_{j + 1} ) = L ( ( {p}_{1} , … {P}_{r} ) )$$

both sides of the inequality and considering the definition of the function L( ) in Equation 2, yields Equation 3.

Property 1 is used to reduce the set of candidate sequenced routes for Q(p,M) by filtering out the points whose distance to p is greater than a threshold, and hence cannot possibly be the optimal route. Note that this property is applicable to all routes in the space.

The answer to the OSR query Q(p,M) demonstrates the following two unique properties. We utilize these properties to improve the exhaustive search among all potential routes of a given sequence.

Property 2: If Q(p,M0=R=(P₁, . . . ,Pₘ₋₁,Pₘ), then Pₘ is the closest point to Pₘ₋₁ in U_{M}_{ₘ}.

Proof: The proof of this property is by contradiction. Assume that the closest point to Pₘ₋₁ in U_{M}_{ₘ} is P_{χ}≠Pₘ. Therefore, we have D(Pₘ₋₁,P_{χ})<D(Pₘ₋₁,Pₘ) and hence L(p,(P₁, . . . Pₘ₋₁, p_{χ}))<L(p,(P₁, . . . , Pₘ₋₁,Pₘ) This contradicts our initial assumption that R is the answer to Q(p,M).

Property 2 states that given that P₁, . . . , Pₘ₋₁ are subsequently on the optimal route, it is only required to find the first nearest neighbor of Pₘ₋₁ to complete the route and subsequent nearest neighbors cannot possibly be on the optimal route and hence, will not be examined. Note that this property does not prove that the greedy route is always optimal. Instead, it implies that only the last point of the optimal sequenced route R(i.e., Pₘ) is the nearest point of its previous point in the route (i.e., Pₘ₋₁).

Property 3: If Q(p,M)=(P₁, . . . ,Pi, Pᵢ₊₁, . . . , Pₘ) for the sequence of M=(M₁, . . . , Mi, Mᵢ₊₁, . . . , Mₘ), then for any point Pᵢ and M=(Mᵢ₊₁, . . . Mₘ), we have Q(Pᵢ,M′)=(Pᵢ₊₁, . . . , Pₘ).

Proof: The proof of this property is by contradiction. Assume that Q(Pᵢ,M′)=R′=(P′₁, . . . , P′ₘ₋₁). Obviously (Pᵢ₊₁, . . . , Pₘ) follows sequence M′, therefore we have L(Pᵢ,R′)<L(Pᵢ,(Pᵢ₊₁, . . . , Pₘ)). We add L(p,(P₁, . . . , Pᵢ)) to both sides of this inequality to get L(p,(P₁, . . . , Pᵢ, P′₁, . . . P′ₘ₋₁))<L(p,(P₁, . . . , Pₘ)).

The above inequality shows that the answer to Q(p,M) must be (P₁, . . . , Pᵢ, P′₁, . . . , P′ₘ₋ᵢ) which clearly follows sequence M. This contradicts our assumption that Q(p,M)=R.

The variables mentioned above are set forth in table 1.

TABLE 1
Summary of notations

| Symbol | Meaning |
|---|---|
| U₁ | a point set in R^{d} |
| \|U₁\| | cardinality of the set U₁ |
| n | number of point sets U₁ |
| D(., .) | distance function in R^{d} |
| M | a sequence, = (M₁, . . . , Mₘ) |
| \|M\| | m, size of sequence M = number of items in M |
| M₁ | i-th member of M |
| R | route (P₁, P₂, . . . , Pᵣ), where P₁ is a point |
| \|R\| | r, number of points in R |
| P₁ | i-th point in R |
| L(R) | length of R |
| p ⊕ R | route Rₚ = (p, P₁, . . . , Pᵣ) where R = (P₁, . . . , Pᵣ) |
| L(p, R) | length of the route p ⊕ R |

Taking advantage of the above, the optimal sequenced route can be determined.

FIG. 4 illustrates a computer system which may be used to calculate the route based on the input points. The processor 200 may operate based on stored instructions on the point set that is stored in the memory 205. The computer may operate according to any of the solutions discussed herein, alone or in flowchart form. The processor 200 may be remote from the requester, and may be queried over a channel such as a cellular phone channel, the internet, or may be directly input to the computer.

This can be calculated based on the so-called “Dijkstra” algorithm.

An OSR query is carried out for a network with a starting point P. A sequence M, and point sets {UM₁ . . . UMₙ}. A weighted directed graph G is constructed for the network. The set V=Uᵢ₌ₘ^{m}U_{M}_{ᵢ}U{p} form the vertices of G. Edges are generated according to the techniques disclosed herein.

The operation proceeds according to the flowchart of FIG. 7. At 700, vertex points are connected. First, the vertex corresponding to p is connected to all the vertices in point set UMN₁. Subsequently, each vertex corresponding to a point X in UMi is connected to all the vertices corresponding to the points in Umᵢ₊₁ where I is between 1 and m−1. FIG. 2 illustrates an exemplary weighted directed graph for a sequence M of this type. The graph is a k bipartite graph, where k=m+1. The weight assigned to each edge of G is based on the distance between the two points corresponding to its 2 vertices.

This graph in fact shows all the possible candidates sequence routes for the given M and the set of Us. Mathematically, this graph shows all the routes Rₚ=p⊕R where R is any candidate sequenced route.

From the definitions above, the optimal route for a given query is the candidate sequence route where Rₚ has the minimum length. 710 illustrates examining all the paths to find the minimum length. Graph G illustrates how the optimal sequenced route can be simply considered as finding the shortest, or minimum weight, paths from p to each of the vertices that correspond to the points in UMₘ. The shortest path is then taken as the optimal route.

This solution may become difficult to implement for larger sets because of the large cardinality of the sets Uᵢ. For example, for a real world data set with 40,000 points and m being 3, the set G may have 124 million edges. The complexity of this technique accordingly scales according to the log of the number of vertices. Also, the graph must be built and maintained in main memory 205. Accordingly, the memory necessary also scales with a log of the number of vertices.

705 illustrates a set reduction technique that reduces the size of the set. Different embodiments implement this in different ways. An embodiment improves the performance of this embodiment might be choose a value L. A range query is then carried out to select only those points that are closer the starting point than L. For example, L may be the route which corresponds to the points of greedy route Rg(p,M), or any other route that can be easily calculated, e.g., using one calculation per leg of the trip. Any point outside this range is longer than the greedy route and hence can be ignored.

Another embodiment calculates the optimal sequenced route in vector space.

This embodiment assumes that the distance function D is the Euclidean distance between points in the space Rd.

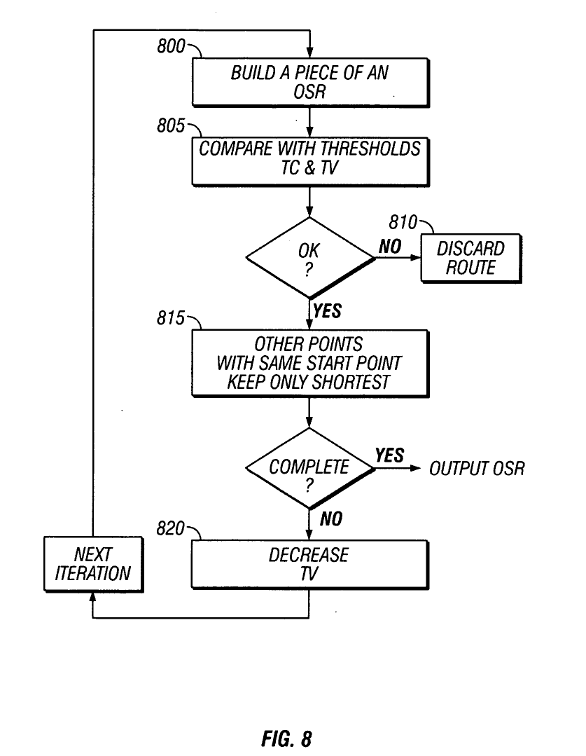

A first embodiment is considered a light algorithm, since it is light in terms of memory usage/workspace required. According to this embodiment, and as shown in 800 of FIG. 8, the computer 200 iteratively builds and maintains a set of partial sequenced routes in reverse sequence, that is starting at the end points (UMₘ) and building towards the start point (p). Each of i iterations adds points from the point set to the head of each of the partial sequenced routes. That makes each of these partial sequenced routes closer to a candidate sequenced route. Finally, the operation converges to a solution, the optimal sequenced route.

This embodiment uses two different thresholds to minimize the amount of work and/or workspace at 805. A variable threshold Tᵥ changes at each iteration. A constant threshold T_{c} represents the length of the greedy route. These thresholds are used to eliminate possibilities, and hence to minimize the size of the solution space. In this embodiment, only those points in the set that can be added to the partial sequenced routes and will not generate routes that are longer than the variable threshold value Tv, are added. The embodiment also examines the partial sequenced routes by calculating their lengths after adding the value p and discards those routes at 810 whose corresponding length is more than a constant threshold value Tc, where Tc is the length of the so-called “greedy” route.

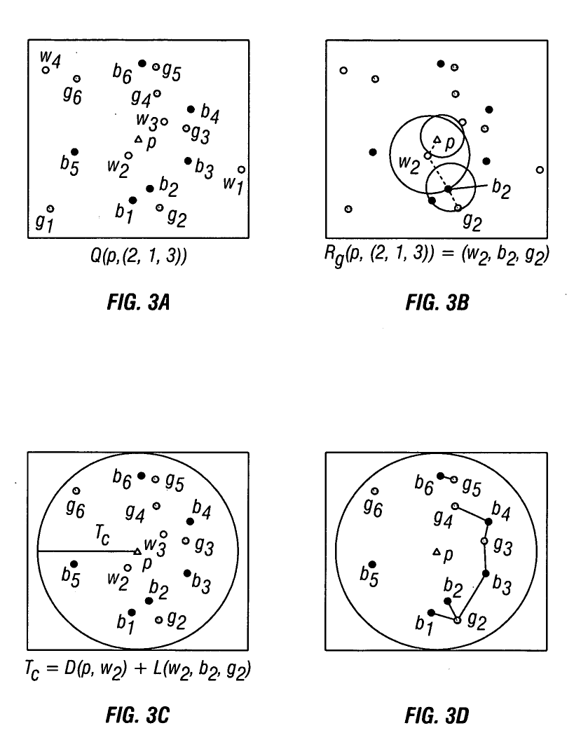

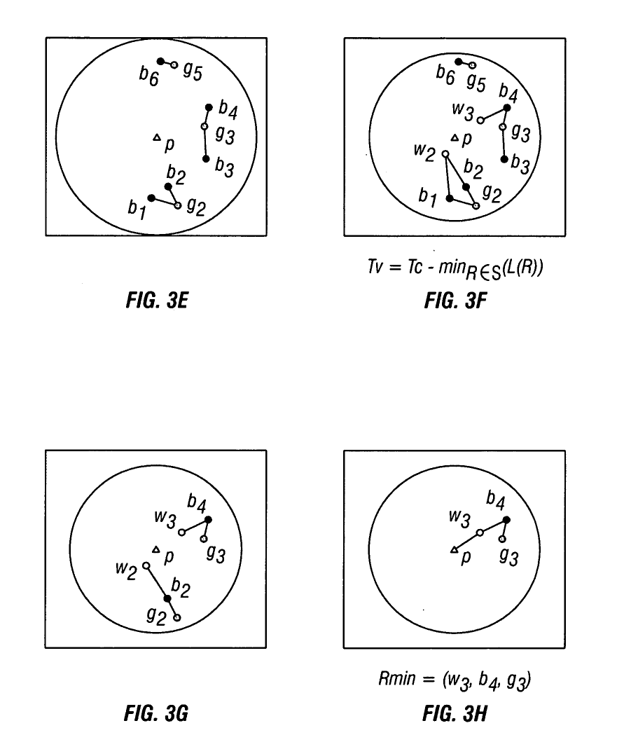

FIG. 3a depicts a starting point of p and 3 different sets of points U1, U2, and U3, which are respectively shown as filled points, hollow points and shaded points. The optimal sequenced route require finding the route r with the minimum L(p,R) from white to black to gray from the start point. The query is therefore formulated as Q(p,(2,1,3))).

The program first issues M=3 consecutive nearest neighbor queries, to find the greedy route that follows 2, 1, 3 from p. This is done, as described above, by first finding the closest w to P, which here is w₂. Then it finds the closest b to w₂, here b₂. Then, it finds the closest g to b₂, here g₂.

FIG. 3b shows the greedy route Rg(p,(2,1,3)) as (w2, b2, g2).

The embodiment initiates a threshold values Tv and Tc to the lengths p+Rg(p,M). The value of Tc remains continuously constant, while the value of Tv reduces after each iteration.

Subsequently, the system discards all the points whose distances p are grater than Tv, that is the points that are outside the circle shown in FIG. 3c. This is because any point outside that circle will lead to a point that is greater than the greedy route, and hence cannot be the optimal route.

The system then generates a set S of partial candidate routes and inserts the “gray nodes” which are inside the circle in FIG. 3c into the set S0. This forms a set S (11).

In the first iteration, each point χεU_{M}_{_{m−1}} is added to the head at each partial sequenced route PSR=(P₁)εS if: a) χ is inside the circle Tv and b) D(p,χ)+D(χ,P₁)+L(PSR)≦T_{c}. For example, FIG. 3d shows b4 being added to g3 and g4, resulting in new partial sequenced routes {(b₄,g₃), (b₄,g₄)} but cannot be added to(g₂), (g₅) and (g₆).

As another simplification, at 815, if there are partial sequenced routes which have the same first point, only the partial sequenced route with the shortest length will be kept in the S, based on property 2.

In addition, any partial sequenced route that cannot have x added to it will be discarded. For example, in FIG. 3d, g₆ is discarded, because any b that is added to it violates one of condition 1 or condition 2.

In the example, at the end of the first iteration, the threshold Tv is decreased at 802 as follows. Suppose that Q(p,M)=(q₁, . . . , qᵢ, . . . ,qₘ) and we are examining iteration (m−i+1) (i.e., the partial SRs in S are in the form of (Pᵢ₊ₘ, . . . ,pₘ)). The definition of the greedy route implies that L(p,(q₁, . . . ,qₘ))≦L(p,R_{g}(p,M))=T_{c} and by considering Property 1, we have:
D(p,qᵢ)+L((qᵢ₊₁, . . . ,qₘ))<D(p,qᵢ)+L((qᵢ, . . . ,qₘ))≦T_{c} which can be rewritten as:
D(p,qᵢ)≦T_{c}−L((qᵢ₊₁, . . . ,qₘ)) (4)

Note that the inequality 4 must hold for all points qᵢ that are to be examined at iteration (m−i+1). Hence, by replacing L((qᵢ₊₁, . . . ,qₘ)) with its minimum value, we obtain the maximum value for D(p,qᵢ) for any qᵢ. Therefore, for any point qᵢ that is examined in iteration (m−i+1), we must have D(p,qᵢ)≦Tᵥ=T_{c}−min_{PSRεS}(L(PSR)).

Note that at each iteration, the lengths of the partial SRs in S, and hence the value of min_{PSRεS}(L(PSR)) is increasing. This yields to smaller values for Tᵥ after each iteration. This is also shown in FIG. 3; the radius of the circle in FIG. 3f is smaller than the radius of the circle in FIG. 3c.

At the end of each iteration, the value of the variable threshold Tv is decreased. {(b₆,g₅), (b₄,g₃), (b₃,g₃), (b₂,g₂), (b₁,g₂)}

The subsequent iterations are performed in a similar way. The partial routes in the set S become more complete routes, that is candidate sequenced routes that follow M after the last iteration is completed. FIG. 3g shows that is.

As the final step, the technique examines the distance from p to the first point in each complete route in the set (i.e., {(w₂,b₂, g₂), (w₃,b₄,g₃)}) and selects the route that generates the minimum total distance, that is the route with a minimum value for the L( ) function as a result of Q(p, (2,1,3)). This is shown in FIG. 3h.

This can be carried out according to the following pseudo code:

Algorithm LORD(point p, sequence M)

| | |
|---|---|
| 1. | S = { }; |
| 2. | Tᵤ = T_{c} = L(p, R_{g}(p, M)); |
| 3. | for q in U_{M}ₘ |
| 4. | if (D(p, q) ≦ Tᵤ) |
| 5. | S = S ∪ {(q)}; |
| 6. | for i = m − 1 downto 1 |
| 7. | S′ = { }; |
| 8. | for q in U_{M}ᵢ |
| 9. | if (D(p, q) ≦ Tᵤ) |
| 10. | S″ = { }; |
| 11. | for R = (P₁, ..., Pₘ₋ᵢ) in S |
| 12. | if (D(p, q) + D(q, P₁) + L(R) ≦ T_{c}) |
| 13. | S″ = S″ ∪ {(q, P₁, . . ., Pₘ₋ᵢ)}; |
| 14. | S′ = S′ ∪ {argmin_{R″∈S″}(L(R″))}; |
| 15. | S = S′; |
| 16. | Tᵤ = T_{c} − min_{R∈S}(L(R)); |
| 17. | Rₘᵢₙ = argmin_{R∈S}(L(p, R)); |
| 18. | return Rₘᵢₙ; |

In the pseudocode, lines 3 through 15 perform the first range queries using a variable threshold, and initializes the set of partial sequenced routes. The iterations are performed in line 6-16. Lines 9 and 12 check to see if a point can be added to the partial sequenced routes, and line 16 updates the value of the variable threshold. Finally, lines 17 returns the minimum 1 as a result of q.

Another embodiment allows the points in Uᵢ to be stored as an R-tree index structure. This embodiment uses the neighborhood information of the points that is inherently stored in the R-tree to more efficiently prune the candidate points at each iteration. In the embodiment, the point selection criterion is changed to a range query of the type that is applicable on an R tree. This point selection can be performed using a single range query.

In this embodiment, and as in the previous embodiment, the system prunes the points in Uₘ. A first pruning step eliminates points of the set that are farther than the variable threshold from the starting point. This is done with a range query (Q₁) using a circle with radius Tᵥ surrounding the starting point p.

A second pruning step checks the points that are returned from the first query step against other partial sequenced routes. If adding a point to that partial sequenced route makes it greater than the length of the greedy route (T_{c}), then the point is not added. Otherwise, a new partial sequenced route is generated.

To identify Range (Q2), we first find the locus of the points x which can possibly be added to a PSR=(pᵢ, . . . ,P_{|PSR|}εS. For such a point x, we must have D(χ,P₁)≦T_{c}−L(PSR) (Line 12 in the psuedocode). As L(PSR) and T_{c} are constant values for a given PSR and query Q(p,M), the sum of χ's distances from two fixed points p and P₁ cannot be larger than a constant. Hence, χmust be on or inside an ellipse defined by the foci p and P₁ and the constant T_{c}−L(PSR). FIG. 5 shows the locus of the points χ for a given route PSR as inside.

To identify Range (Q2), we first find the locus of the points χ which can possible be added to a PSR=(P₁, . . . , P_{|PSR|})εS. For such a point χ, we must have D(χ,p)+D(χ,pₗ)≦T_{c}−L(PSR) (Line 12 in the psuedocode). As L(PSR) and T_{c} are constant values for a given pSr and query Q(p,M), the sum of χ's distances from two fixed points p and P₁ cannot be larger than a constant. Hence, χmust be on or inside an ellipse defined by the foci p and P₁ and the constant T_{c}−L(PSR). FIG. 5 shows the locus of the points χfor a given route PSR as inside and on an ellipse E(p,PSR).

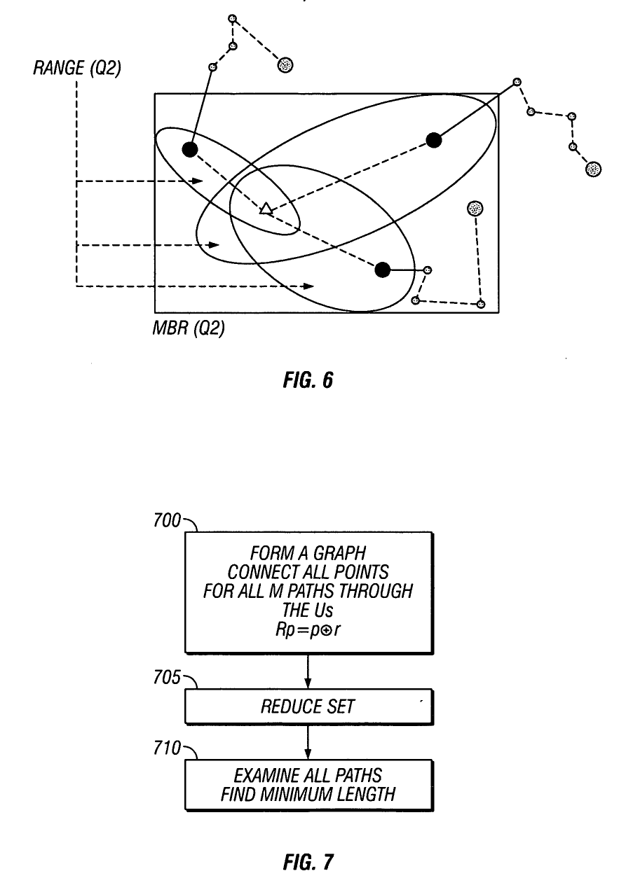

Query Q2 is defined in terms of the set of partial SRs stored in S in the current iteration. For each PSR, points are appended inside ellipse E(p,PSR) to the head of the PSR in order to build a new partial candidate route. All such ellipses, each corresponding to a partial SR in S, are intersecting as they all share the common focus point p. The union of these ellipses contains all the points X (of the appropriate set), where for each, there is exactly one route starting with X built at the end of the current iteration. In other words, this union should be the range used in query Q2. FIG. 6 illustrates an example for the current set S during an iteration of the computer operation. The set includes three partial SRs of the same length, each starting with a black point. The sequence M of the query Q(P,M) dictates the type of the point which must be added to the head of each partial SR. Any point outside the union of these three ellipses is ignored by the program.

Up to this point, we have identified the range of the two main queries Q1 and Q2 used in the program. The following shows that any ellipse for the range Q2 is entirely inside the circle for range Q1 and hence, the range of Q2 is completely inside that of Q1.

Lemma 1. During each iteration of the program for Q(p,M), given a partial SR PSRεS, any point χ inside or on the ellipse E(p,PSR) has a distance less than current value of the variable threshold Tᵥ from point p (i.e., D(χ,p)<Tᵥ).

Proof. As point χ is inside or on ellipse E(p,PSR) corresponding to the route PSR, we have

$$D ( χ , p ) \leq {T}_{c} - L ( PSR ) \leq {T}_{c} - {min}_{PSR ∈ A} ( L ( PSR ) ) \qquad ( 5 )$$

The right side of the above inequality has the same value as that of the current value of Tᵥ. It directly yields that D(χ,p)≦Tᵥ−D(χ,P₁) and subsequently, we have D(χ,p)<Tᵥ.

Lemma 1 shows that any ellipse E(p,PSR) is completely inside the circular range of Q1. Now, as Range (Q2) is the union of all ellipses E(p,PSR) corresponding to all the partial SRs in S, it can be concluded that it is entirely inside Range (Q1).

Note that at each iteration, the program builds a new route using only the points in the intersection of Range (Q1) and Range (Q2). Given Lemma 1, this intersection is the same as Range (Q2). Hence, the algorithm must only consider the points which are within the range of Q2 from p, to be added to the partial SRs in S.

This embodiment acts as an R-tree Friendly Program by transforming the threshold values into range queries that can be performed on R-tree index structures. The above has shown that the two range queries Q1 and Q2 employed by the program can be reduced to only one, as Q2 is entirely inside Q1. However, as FIG. 6 illustrates, the range specified by Q2 (union of the ellipses) is a complex parameterized curved shape which cannot be efficiently handled by an R-tree range query algorithm. To make this range simpler, we employ a minimum bounding box (MBR (Q2)) as shown in FIG. 6. However MBR (Q2) is no longer inside the range of Q1. Therefore, the R-tree version of the program instead uses the intersection of MBR (Q2) and Range (Q1) to examine the points in U_{M}_{ᵢ}′s.

To retrieve the points in a specific range, we need to traverse the R-tree from its root down to the leaves and report those points that are within the given range. To make the search efficient, existing search algorithms on R-tree prune subtrees of the main tree utilizing some metrics. The most common metric, mindist(N,q), provides a lower bound on the smallest distance between the point q and any point in the subtree of node N. We utilize the minimum distance for Q1 as its range is relative to a fixed point p. Any Rj-tree node N with mindist(N,p) greater than threshold Tᵥ cannot contain a point q with the distance D(p,q) less than or equal to Tᵥ. Such node can be easily pruned when traversing the R-tree during our first range query (i.e., Q1). Moreover, query Q1 is used to initialize the PSRs of LORD (Line 3-5 in the psuedocode).

FIG. 7 shows how the mindist metric can be used in Q1 to initialize the set of routes S. It also demonstrates the way a circular range query can be answered on an R-tree.

The second rectangular range query (i.e., MBR (Q2)) can be performed as follows. We first check whether a node N of the R-tree intersects with the rectangle. If their intersection is empty, the node N is pruned; otherwise, the child nodes of N must be checked for their intersection with MBR (Q2).

Now that both of the range queries used to select the points have been selected, and their use has been studied, another embodiment, called R-LORD is described: the R-tree version of LORD. A difference between R-LORD and LORD is that R-LORD incorporates the R-tree implementation of two range queries of LORD in its iterations. First, it initializes the set S, with the partial SRs of length zero, each including a single point of the set of points returned from the function RQ1(p,T_{c},Mₘ) (FIG. 7). Then, in each iteration, R-LORD traverses the entire R-tree starting from the root to prune the nodes that are outside MBR (Q2) and Range (Q1) and then selects the points that must be added to the PSRs. At the end of each iteration, R-LORD updates MBR (Q2) by examining the recently built PSRs in S.

The embodiments discussed above may be efficiently carried out in vector space. However, these embodiments may be difficult to use in a metric space. Certain of the functions applied above may render it difficult to use these features in metric spaces where the distance is usually a computationally complex function.

Another embodiment, intended for use in metric space, uses progressive neighbor exploration to address optimal sequenced route queries in metric spaces for arbitrary values of M. Progressive neighbor exploration incrementally creates a set of candidate routes for Q(p,M) in the same sequence as M, that is from p to Umm. In the embodiment, this is done through an iterative process which starts by examining the nearest neighbor to P in the set U, enerates the partial sequenced route from P to this neighbor, and stores the candidate route in a heat based on its length. Each subsequent iteration examines the sequenced route partials from top to bottom. Each examination is as follows.

1. If |PSR|=m, meaning that the number of nodes in the partial SR is equal to the number of items in M and hence PSR is a candidate SR that follow M, the PSR is selected as the optimal route for Q(p,M) since it also has the shortest length.

2. If |PSR|≠m:

(a) First the last point in PSR,r_{|PSR|}, (which belongs to U_{M}_{_{|PSR|}} is extracted and its next nearest neighbor in U_{M}_{_{|PSR|+1′|PSR|+1}}, is found. This will guarantee that a) the sequence of the points in PSR always follows sequence specified in M, and b) the points that are closer to r_{|PSR|} and hence may potentially generate smaller routes are examined first. The fetched PSR is then updated to include r_{|pSR|+1} and is put back in to the heap.

(b) We then find the nearest neighbor in U_{M}_{_{|PSR|}} to r_{|PSR|-1},r′_{|PSR|}, generate a new partial SR PSR′=(r₁,r₂, . . . , r_{|PSR|-1},r′_{|PSR|}), and place the new route in to the heap. This is because once the point r_{|PSR|}, which we can assume is the k-th nearest point in U_{M}_{_{|PSR|}} to r_{|PSR|-1}, is chosen in step (a) above, the (k+1)-st nearest point in U to r_{|PSR|-1} (e.g., r′_{|PSR|}) is the only next point that may generate a shorter route and hence, must be examined. If |PSR|=1, we find the next nearest point in U_{M}_{₁} to p.

A concrete example is described using the above example. The weighted directed graph of FIG. 2 illustrates the values that are stored in the heat in each step of the iteration. In step one, the nearest gi to p is found and the first partial sequenced route along with its distance is stored up (g2²) in the heat. In step two, that first distance is fetched from the heat. For routes that are partial sequenced routes not equal to three, steps to a pen to be above are performed. First, the next nearest li to g2, l2 is found. A partial sequenced route is updated by adding l2 to that route. The updated route is placed back in the heap.

Next, the next nearest gi to p,g1 is found and placed into the heap. Similarly to the above, this process repeats until the route on the top of the heap follows only the sequence m.

Note that this technique requires keeping only one candidate sequenced route in the heap. If during any step 28, a route with m the points is generated, it is only added to the heap if there is no other candidate sequence route that has a shorter length in the heap. Moreover, any time a candidate sequenced route is added to the heap, any other sequenced route with a longer length is discarded. For example, table 2 illustrates the different steps. For example, in step 6, adding the route (g₂,l₃,p₃) with the length of 14 to the heap will result in discarding the route (g₂,l₂,p₂) with the length of 15 from the heap (crossed out in the Figure).

The only requirement for PNE is a nearest neighbor approach that can progressively generate the neighbors. Hence, by employing an approach similar to INE [16] or VN³ [12], which are explicitly designed for metric spaces, PNE can address OSR queries in metric spaces. In theory PNE can work for vector spaces in a similar way; however, it is inefficient for these spaces where distance computation is not expensive. The reason is that PNE explores the candidate routes from the starting point which might result in an exhaustive search. Instead, R-LORD optimizes this search by building the routes in the reverse sequence utilizing the RO-tree index structure.

| step | heap contents (candidate route R : L(p, R) ) |
|---|---|
| 1 | (g₂ : 2) |
| 2 | (g₁ : 3), (g₂, l₂ : 4) |
| 3 | (g₂, l₂ : 4), (g₃ : 4), (g₁, l₂ : 6) |
| 4 | (g₃ : 4), (g₂, l₃ : 5), (g₁, l₂ : 6), (g₂, l₂, p₂ : 15) |
| 5 | (g₂, l₃ : 5), (g₄ : 5), (g₁, l₂ : 6), (g₃, l₂ : 6) |
| | (g₂, l₂, p₂ : 15) |
| 6 | (g₄ : 5), (g₁, l₂ : 6), (g₃, l₂ : 6), (g₂, l₁ : 12) |
| | (g₂, l₃, p₃ : 14), (g₂, l_{2+L, p}₂ : 15) |
| 7 | (g₁, l₂ : 6), (g₃, l₂ : 6), (g₄, l₃ : 11), (g₂, l₁ : 12) |
| | (g₂, l₃, p₃ : 14) |
| 8 | (g₃, l₂ : 6), (g₁, l₃ : 9), (g₄, l₃ : 11), (g₂, l₁ : 12) |
| | (g₂, l₃, p₃ : 14), (g₁, l_{2+L, p}₂ : 17) |
| 9 | (g₁, l₃ : 9), (g₃, l₃ : 9), (g₄, l₃ : 11), (g₂, l₁ : 12) |
| | (g₂, l₃, p₃ : 14), (g₃, l_{2+L, p}₂ : 17) |
| 10 | (g₃, l₃ : 9), (g₁, l₁ : 10), (g₄, l₃ : 11), (g₂, l₁ : 12) |
| | (g₂, l₃, p₃ : 14), (g₁, l_{3+L, p}₃ : 18) |
| 11 | (g₁, l₁ : 10), (g₄, l₃ : 11), (g₂, l₁ : 12), (g₃, l₁ : 12) |
| | (g₂, l₃, p₃ : 14), (g₃, l_{3+L, p}₃ : 18) |
| 12 | (g₄, l₃ : 11), (g₂, l₁ : 12), (g₃, l₁ : 12), (g₁, l₁, p₁ : 12) |
| | (g₂, l₃, p₃ : 14) |
| 13 | (g₂, l₁ : 12), (g₃, l₁ : 12), (g₁, l₁, p₁ : 12) |
| | (g₄, l₃, p₃ : 20) |

Another embodiment adds the additional parameter of a separate endpoint to any of the above embodiments.

Initially, this is defined as a query:

Definition 8: Given source point p, destination point q and a sequence M, the OSR-I query is defined as R=(P₁, . . . , Pₘ), a sequenced route that follows M, where the following function G is minimum over all sequence routes that follow M:
G(p,R,Q)=D(p,P₁)+L(R)+D(Pₘ,q) (6)

The above equation is similar to L(p,R)+D(Pₘ,q). We show that this new form of OSR can easily be reduced to the general form of OSR.

We define a new set of Uₙ₊₁={q}. Including this new set in the set of Uᵢ's makes M′={M₁, . . . , Mₘ, n+1) a valid sequence in the new setting of the problem. Now if we assume that Q(p,M′)=R′=(P′₁, . . . , P′ₘ₊₁), we know that P′ₘ₊₁ will be q as q is the only member of Uₙ₊₁. Moreover, L(p,R′) is minimum over all candidate routes that follow M′. Recall that the length of the route R′ₚ=p⊕R′ (i.e., L(p,R′)) is equal to D(p,P′₁)+L(R′). We define the route R as (P′₁, . . . , P′ₘ) by excluding q from R′. It is clear that L(p,R′) is the same as D(p,P₁)+L(R)+D(Pₘ,q). By comparing the latter expression with G(p,R,q) of Equation 6, we conclude that R is the answer to the OSR-I query given the source p, destination q and sequence M.

Since we have shown that OSR-I can be reduced to a general OSR problem, we are able to use our LORD (or R-LORD) algorithm to answer this query. Specifically, the answer to OSR-I given the source p, destination q, and sequence M is the same as the answer to LORD(p,M′) excluding the point q, where Uₙ₊₁={q} and M′=(M₁, . . . ,Mₘ,n+1). Although R-LORD can similarly solve OSR-I, we can further optimize it for OSR-I. This is achieved by neglecting the range query Q1 (i.e., RQ1(p,T_{c},n+1)). This is because we know that the only point in this range is q. Therefore, the set S can be directly initialized to {(q)}.

The second variation of OSR is when the user asks for the k routes with the minimum total distances to its location. We define this as k-OSR query. We can easily address this type of query using our PNE approach discussed above.

Recall that in PNE, we maintain a heap of the partially completed sequenced routes and only keep one candidate sequenced route (or, in other words, a route that follows M), that is the one that has the minimum total length. By modifying this policy to maintain k candidate SRs in the heap and continuing the iterations until k candidate SRs are fetched from the heap, PNE can also address k-OSR queries.

Although only a few embodiments have been disclosed in detail above, other embodiments are possible and the inventor(s) intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other computers may be used, and may calculate the values in other space.

The computers described herein may be any kind of computer, either general purpose, or some specific purpose computer such as a workstation. The computer may be a Pentium class computer, running Windows XP or Linux, or may be a Macintosh computer. The programs may be written in C, or Java, or any other programming language. The programs may be resident on a storage medium, e.g., magnetic or optical, e.g. the computer hard drive, a removable disk or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A method, comprising:
obtaining a set of points, including a plurality of categories defined within the points; and
using a computer to determine an optimal sequenced route from a start point to one point in each said category.

2. A method as in claim 1, wherein said using the computer to determine comprises determining each of a plurality of possible paths through the categories, and finding the shortest said path.

3. A method as in claim 2, wherein said using the computer to determine further comprises reducing the set of paths.

4. A method as in claim 3, wherein said reducing comprises first computing a path using a technique that finds a first path using a single analysis step for each segment of the path, and then removing any path which has an aspect that is longer than said first path.

5. A method as in claim 3, wherein said reducing comprises comparing each of the set of paths to another path, and deleting paths which are not unique.

6. A method as in claim 1, wherein said using a computer carries out processing in metric space.

7. A method as in claim 1, wherein said using a computer carries out processing in vector space.

8. A method as in claim 7, wherein said processing in vector space maintains a set of partial sequenced routes, and iteratively adds additional partial sequenced routes to make more complete partial sequenced routes.

9. A method as in claim 8, wherein said iteratively adds comprises first checking each additional partial sequenced route against a threshold, and rejecting a partial sequenced route which exceed said threshold.

10. A method as in claim 9, wherein said threshold includes a fixed threshold indicative of a length of a greedy route.

11. A method as in claim 9, wherein said threshold includes a fixed threshold indicative of a length of a route determined using a single analysis step for each segment of the path.

12. A method as in claim 9, wherein said threshold includes a variable threshold indicative of a length of previous items in the set.

13. A method as in claim 1, wherein said using a computer comprises forming a query to said set of points which returns an answer.

14. A method as in claim 1, wherein said set of points is optimized for use with an R-tree

15. The method as in claim 14, wherein said using the computer comprises forming range queries forming at least one range query and using a bounding box to reject any route which is outside the range query.

16. A method as in claim 9, wherein the threshold is a metric threshold.

17. A method as in claim 9, wherein the threshold is a circular threshold implemented as a range query.

18. A method as in claim 1, wherein said using a computer comprises analyzing an R-tree index structure.

19. A method as in claim 17, further comprising reducing the number of results by excluding results outside a bounding box.

20. A method, comprising:
obtaining information indicative of a plurality of categories, and a plurality of points for each of the categories;
iteratively determining plural partial sequenced routes for each of the plurality of categories;
eliminating at least some of the partial sequenced routes by comparing each of said partial sequenced routes with a threshold, to form a reduced set of partial sequenced routes; and
using said reduced set to form an optimal sequenced route through one point in each of the plurality of categories.

21. A method as in claim 20, wherein said eliminating comprises comparing with a first constant threshold, and with a second variable threshold.

22. A method as in claim 21, wherein said thresholds are vector values.

23. A method as in claim 21, wherein said thresholds are values that are optimized for use with an R tree.

24. A method as in claim 21, wherein said constant threshold is the length of a route which is calculated non-iteratively.

25. An apparatus, comprising:
A memory, storing a set of points, and storing a relationship that includes a plurality of categories defined within the points; and
a computer to determine an optimal sequenced route from a start point to one point in each said category.

26. An apparatus as in claim 25, wherein said computer determines each of a plurality of possible paths through the categories, and operates to find the shortest said path.

27. An apparatus as in claim 26, wherein said computer reduces the set of paths to minimize an number of said paths.

28. An apparatus as in claim 27, wherein said computer reduces paths using a technique that finds a first path using a single analysis step for each segment of the path, and then removing any path which has an aspect that is longer than said first path.

29. An apparatus as in claim 28, wherein said computer forms partial sequenced routes and iteratively adds to said partial sequenced routes, by first checking each additional partial sequenced route against a threshold, and rejecting a partial sequenced route which exceeds said threshold.

30. An apparatus as in claim 29, wherein said threshold includes a fixed threshold indicative of a length of a greedy route.

31. An apparatus as in claim 29, wherein said threshold includes a fixed threshold indicative of a length of a route determined using a single analysis step for each segment of the path.

32. An apparatus, comprising:
a memory, storing information indicative of a plurality of categories, and a plurality of points for each of the categories;
a computer, iteratively determining plural partial sequenced routes for each of the plurality of categories, and eliminating at least some of the partial sequenced routes by comparing each of said partial sequenced routes with a threshold, to form a reduced set of partial sequenced routes and storing the partial sequenced routes, and using said reduced set to form an optimal sequenced route through one point in each of the plurality of categories.

33. An apparatus as in claim 32, wherein said computer uses a first constant threshold, and with a second variable threshold for said eliminating.

34. An apparatus as in claim 33, wherein said thresholds are values that are optimized for use with an R tree.

35. An apparatus as in claim 21, wherein said constant threshold is the length of a route which is calculated non-iteratively.
